(19) United States
(12) Patent Application Publication
(10) Pub. No.: US 2018/0268376 A1
(43) Pub. Date: Sep. 20, 2018

(54) FACILITY MANAGEMENT SYSTEM USING PERSPECTIVE DEFINITION METADATA AND METHOD THEREFOR

(71) Applicant: KOREA INSTITUTE OF CONSTRUCTION TECHNOLOGY, Goyang-si (KR)

(72) Inventors: Tae Wook KANG, Seoul (KR); Hyun Sang CHOI, Goyang-si (KR)

(21) Appl. No.: 15/981,155

(22) Filed: May 16, 2018

Related U.S. Application Data
(63) Continuation-in-part of application No. 14/313,178, filed on Jun. 24, 2014.

(30) Foreign Application Priority Data
Dec. 3, 2013 (KR) 10-2013-0149113

(51) Int. Cl. G06Q 10/00; G06Q 50/16

(52) U.S. Cl. CPC G06Q 10/20; G06Q 50/163

(57) ABSTRACT

A facility management system and a method thereof using perspective definition metadata, and more specifically, to a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

### CROSS-REFERENCE TO RELATED APPLICATIONS

This application is a continuation-in-part application of application Ser. No. 14/313,178, filed Jun. 24, 2014, and claims priority to and the benefit of Korean Patent Application No. 10-2013-0149113, filed on Dec. 3, 2013, and all the benefits accruing therefrom under 35 U.S.C. § 119, the content of which is incorporated herein in its entirety by reference.

### BACKGROUND OF THE INVENTION

### Field of the Invention

The present invention relates to a facility management system and a method thereof using perspective definition metadata, and more specifically, to a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

### Background of the Related Art

Recently, studies on management of facilities based on Building Information Modeling (BIM) are under progress, and interoperability among heterogeneous data sources considering expandability and convenience from the perspective of a user is emerging as an issue.

In the field of construction, although a Building Smart Association or the like is trying to develop and standardize Industry Foundation Classes (IFC) and accommodate requirements of the industry for smooth interoperatility of information, a problem such as loss or modification of some information when data are exchanged among models in the working level is reported (Lim Jae-In, 2008.6).

Although it is tried to solve the problem of ambiguity or the like in the expression of construction information through the recently announced IFC4, it is a part which is still under improvement, and associations among the related measures are insufficient. If the perspective of a system user is fixed and invariable when a Facility Management (FM) system is implemented, there may be a problem in the management and reusability functions of the system since the system cannot be expanded.

As a conventional related technique, a technique using a Model View Control (MVC) pattern in a software architecture design pattern developed in the field of software engineering may be one of techniques related to expressing and processing information according to a perspective of a user using BIM.

The design pattern is a method contrived to solve the system design problem of a specific area, which is defined by Erich Gamma et al. who are called as Gang of Four (GoF) by patterning the design knowhow found in the process of solving the problems frequently appeared in the development of a system.

The MVC pattern is a structure designed to separate a data model, a controller for processing data and a view for expressing the data so that other components may not be affected although the view is changed. Therefore, since views of diverse perspectives can be defined by deriving a view from a base class, perspectives of information expression desired by a user can be easily expanded. In addition, since the model is independent of the controller having business logic, it is not affected although the logic is changed, and thus managability is improved.

A technique developed by Umit Isikdag focusing on a collaborative process among interested parties of a project in a BIM-based process is a technique utilizing a design pattern for BIM. Utilization of a design pattern is proposed as a method of synchronizing information needed for a view according to a perspective of viewing information generated in the collaborative process, and a method of applying the MVC pattern to a domain and a method of processing an event by an MVC-related component to synchronize information when a change is occurred in the model are described and developed (Umit Isikdag, Jason Underwood, 2010, Two design patterns for facilitating Building Information Model-based synchronous collaboration, Automation in Construction, 19, 544-553).

A design pattern technique for supporting a Service Oriented Architecture (SOA) to share BIM information based on the web is another related technique, and this technique has proposed an SOA which applies three design patterns to efficiently exchange and share the web-based BIM information (Umit Isikdag, 2012, Design patterns for BIM-based service-oriented architectures, Automation in Construction, 25, 59-71).

However, although the MVC design pattern supports expressions of information according to a perspective, since the perspective of information expression is fixed when a system is developed, the system cannot have variability and expandability after being developed.

An Extract Transform Load (ETL) technique or the like for constructing a Data Warehouse (DW) in the field of management engineering or the like is a technique related to interconnection of heterogeneous system data.

In the field of GIS, the DW is expanded to a Spatial Data Warehouse (SDW) by including spatial data, and a study on storing spatial information and non-spatial property information as subject-oriented, integrated and time-variant nonvolatile data has been conducted to support analysis and decision making (S. Chaudhuri, 1997).

The SDW can be created and updated to be subject-oriented through the ETL. It is disclosed that, in a technique related to the BIM, spatial data extracted and stacked from diverse heterogeneous system data through an EFL process should have a structure capable of supporting a data analysis request on the DW (Konstantin Krivoruchko, 2003).

In addition, a technique developed by H. Ufuk Gokce and K. Umut Gokce is another related technique, and there is an example of implementing a system by extracting, transforming and stacking data using an ETL in an energy management system (H. Ufuk Gokce, 2011).

The technique developed as described above points out that utilization of a single integrated information model is difficult in an environment in which interested parties of a project use a database in a different way. In order to avoid such a problem, sensor data including multi-dimensional data and architecture of extracting building information from data sources are proposed.

In a technique related to BIM-based facility management, Ko (Ko, Y. H. 2008, A Study on the Development of a BIM-Based Building Process of CAFM Basic Data, Seoul National University of Technology) pointed out that the cost required for developing BIM-based Computer Aided Facility Management (CAFM) is too high if BIM data are used when the CAFM is constructed, and proposed a technique capable of using the BIM data that can be utilized in the stage of FM based on IFC and Construction Operations Building Information Exchange (COBie). However, the method has only been proposed, and its utilization has never been verified through a demonstration.

Lim (Lim, H. S. 2011.7, BIM-based Mobile System for Facility Operation Improvement, Yonsei University) has focused on improvement of communication through smooth exchange of information among management subjects through a mobile BIM-based management system and support of a smooth work by constructing plans and maintenance works as a database.

An (An, H. K, Lee, S. K, Yu, J. H, Jang, H. S, Son, B. S. 2012.11, Information Requirements Analysis for BIM-based Facility Management Systems, Architectural Institute of Korea, 28(11):133-142) has reviewed requirement information data, divided the data into prerequisite information, recommended information and selective information, and proposed data which can be referenced when a facility management system is constructed, based on the COBie through consultation in order to define requirements for a BIM-based facility management system.

Conclusively, observing the techniques related to the present invention, techniques applying a design pattern for collaboration or web-based information sharing are studied, and a research which has developed a SDW in the field of GIS has been conducted as a study related to extraction and transformation of external heterogeneous data. Techniques related to the BIM-based FM are mostly a technique related to construction of a database or utilization of a COBie format, and techniques related to the metadata structure for interconnecting the BIM and external FM data considering variability and expandability from the perspective of a user are insufficient.

### SUMMARY OF THE INVENTION

Therefore, the present invention has been made in view of the above problems, and it is an object of the present invention to provide a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

To accomplish the above object, according to one aspect of the present invention, there is provided a facility management system using perspective definition metadata, the system including: a central server 100 for receiving a request for maintenance from a user terminal 200, confirming work/maintenance history information from the facility management database 110, confirming information on a location, a structure and history of work/maintenance from the facility management database 110, transmitting a request for a quotation of the work of a company to the facility management company server 300, receiving a request for data related to the work on a site from the facility management company server 300, transmitting the data related to the field work to the facility management company server 300, receiving information on the quotation of the work of the company from the facility management company server 300, requesting the management information system 400 to approve progress of the work, receiving information on approval of progressing the work from the management information system 400, transmitting a contract with the company and a request for the work to the facility management company server 300, receiving information on results and products before and after the maintenance work from the facility management company server 300, transmitting a request for on-site confirmation on the result of the maintenance work to the user terminal 200, updating history of drawings and documents in the facility management database 110, receiving a request for payment of work expenses from the facility management company server 300, requesting the management information system 400 to approve the work expenses, receiving approval of the work expenses and information on registration of history from the management information system 400, receiving the result of the maintenance work from the user terminal 200, and transmitting information on the payment of the work expenses to facility management company server 300; a user terminal 200 for transmitting a request for maintenance to the central server 100, receiving a request for on-site confirmation on the result of the maintenance work from the central server 100, and transmitting the result of the maintenance work to the central server 100; a facility management company server 300 for receiving a request for a quotation of the work of the company from the central server 100, transmitting a request for data related to the field work to the central server 100, receiving the data related to the field work from the central server 100, transmitting information on the quotation of the work of the company to the central server 100, receiving a contract with the company and a request for the work from the central server 100, transmitting information on results and products before and after the maintenance work to the central server 100, transmitting a request for payment of work expenses to the central server 100, and receiving information on the payment of the work expenses from the central server 100; and a management information system 400 for receiving a request for approving progress of the work from the central server 100, transmitting information on approval of progressing the work to the central server 100, receiving a request for approving the work expenses from the central server 100, and transmitting approval of the work expenses and information on registration of history to the central server 100.

At this point, the central server 100 includes: a collection means for collecting heterogeneous data related to facility management from a separate system in a form of an XML file; a classification means for classifying the heterogeneous data collected by the collection means according to a classification target criterion configured of a user's perspective, a manager's perspective and a worker's perspective; and an expression means for expressing the heterogeneous data classified by the classification means on a screen of the user terminal 200, a separate manager terminal or a separate worker terminal in a classified style.

According to another aspect of the present invention, there is provided a facility management method using perspective definition metadata, the method including the steps of: (A) receiving a request for maintenance from a user terminal 200, by a central server 100; (B) confirming information on a location, a structure and history of work/maintenance from a facility management database 110, by the central server 100; (C) transmitting a request for a quotation of the work of a company to a facility management company server 300, by the central server 100; (D) receiving a request for data related to the work on a site from the facility management company server 300, and transmitting the the data related to the field work to the facility management company server 300, by the central server 100; (E) receiving the quotation of the work of the company from the facility management company server 300, by the central server 100; (F) requesting a management information system 400 to approve progress of the work, and receiving approval of progressing the work from the management information system 400, by the central server 100; (G) transmitting a contract with the company and a request for the work to the facility management company server 300, and receiving information on results and products before and after the maintenance work from the facility management company server 300, by the central server 100; (H) transmitting a request for on-site confirmation on the result of the maintenance work to the user terminal 200, by the central server 100; (I) receiving a request for payment of work expenses from the facility management company server 300, by the central server 100; (J) requesting the management information system 400 to approve the work expenses, and receiving approval of the work expenses and information on registration of history from the management information system 400, by the central server 100; (K) receiving the result of the maintenance work from the user terminal 200, and by the central server 100; and (L) transmitting information on the payment of the work expenses to facility management company server 300, by the central server 100.

### BRIEF DESCRIPTION OF THE DRAWINGS

FIG. 1 is a reference view related to an FM work for conventional facility management.

FIG. 2 is a view showing the entire configuration of a facility management system using perspective definition metadata according to a preferred embodiment of the present invention.

FIG. 3 is an entire flowchart illustrating a facility management method using perspective definition metadata according to a preferred embodiment of the present invention.

### DESCRIPTION OF SYMBOLS

| | |
|---|---|
| 100: Central server | 110: Facility management database |
| 200: User terminal | 300: Facility management company server |
| 400: Management information | |
| system | |

### DETAILED DESCRIPTION OF THE PREFERRED EMBODIMENT

Before describing the preferred embodiments of the present invention in detail, terms and words used in this specification and claims should be interpreted as meanings and concepts to meet the technical ideas of the invention based on the principles that can define adequately the concept of the terms so that the inventor can explain his or her invention in the best way.

In addition, if already known functions or specific description of constitution related to the present invention may make the spirit of the present invention unclear, detailed description thereof will be omitted.

The inventors of the present invention have completed the present invention by developing a BIM-based Perspective Definition Metadata (BPD) structure which can interconnect BIM and external Facility Management (FM) data considering variability and expandability from the perspective of a user.

Since the perspective definition metadata supports variability of a system for adding or changing perspectives of a user even after the system is developed, it may be helpful in expanding and reusing the system. Since the perspective definition metadata extracts only the data needed from the perspective of a user from heterogeneous data sources and transforms the extracted data to be shown in a style desired by the user, it is configured of a data model defining data which will be extracted, transformation logic defining how to transform the extracted data, and a view defining how to show the transformed data.

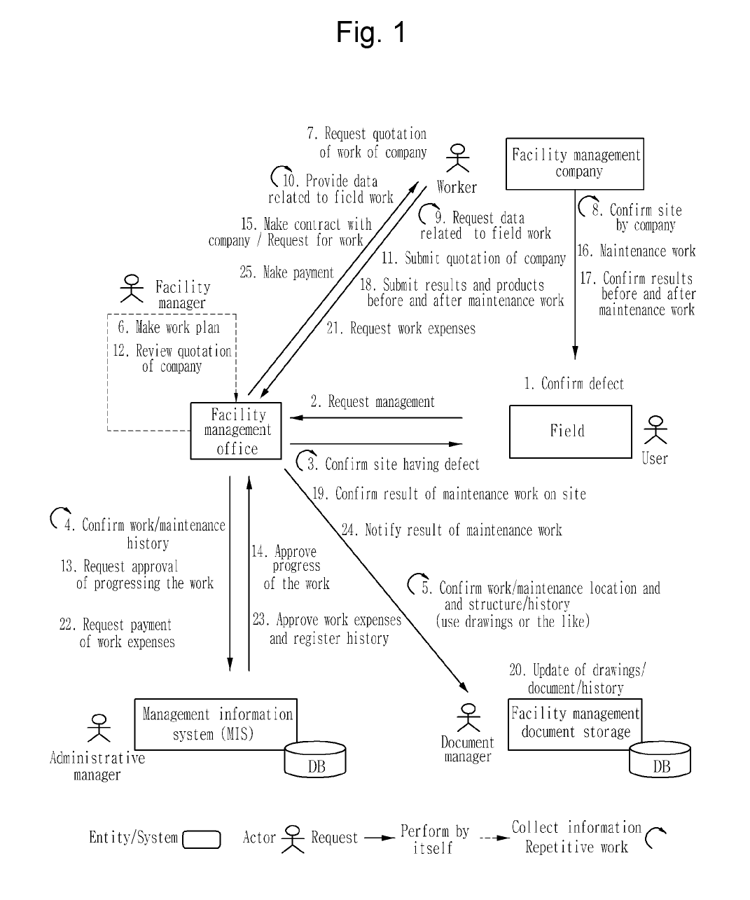

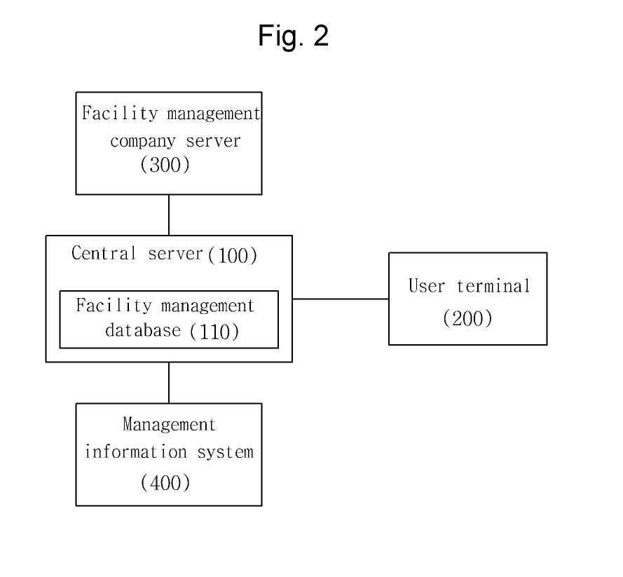

Hereinafter, a facility management system using perspective definition metadata according to a preferred embodiment of the present invention will be described in detail with reference to FIGS. 1 and 2.

FIG. 1 is a reference view related to an FM work for conventional facility management, and FIG. 2 is a view showing the entire configuration of a facility management system using perspective definition metadata according to a preferred embodiment of the present invention.

An FM work scenario applied to conventional facility management or the like by a public organization or the like which manages facilities is as described below, and this is shown in FIG. 1. A facility management work has an extremely complicated work flow, and various interested parties of a project take part in the work. If a defect occurs in a facility, a management company, a technique thereof or the like will be changed according to the type of the facility, and it takes a long time in many cases to collect related data and identify a cause in the process of a maintenance work.

1. A user confirms a defect of a facility.

2. The user requests maintenance of the facility.

3. A facility manager visits the site and confirms the defect.

4. The facility manager confirms work/maintenance history. Specifically, the facility manager confirms the work/maintenance history related to the defect and confirms information on a company or the like which has performed the work before.

5. The facility manager confirms a location, a structure and history of the work/maintenance. Specifically, the facility manager confirms information related to the facility to grasp causes and countermeasures of the defect using drawings or the like.

6. The facility manager makes a work plan.

7. The facility manager requests a quotation of the work from the company.

8. A worker confirms the site of the facility. Specifically, the worker grasps causes and makes a maintenance plan after confirming the site.

9. The worker requests data related to the field work.

10. The facility manager provides data related to the field work. Specifically, the facility manager collects and provides facility-related data requested by the company.

11. The worker submits the quotation of the company.

12. The facility manager reviews the quotation of the company.

13. The facility manager requests approval of performing the work.

14. The administrative manager approves progress of the work.

15. The facility manager makes a contract with the company and requests progress of the work.

16. The worker performs a maintenance work.

17. The worker confirms results before and after the maintenance work.

18. The worker submits the results and products before and after the maintenance work.

19. The facility manager performs on-site confirmation on the result of the maintenance work.

20. The facility manager updates history of drawings and documents.

21. The worker requests work expenses.

22. The facility manager requests approval of the work expenses.

23. The administrative manager approves the work expenses and registers history of the work.

24. The facility manager notifies the result of the maintenance work.

25. The facility manager makes a payment for the work.

Seeing a result of analyzing the work scenario described above, it is understood that since data and information on the site such as drawings, history information, related documents and the like are scattered, a lot of repetitive manual works are required in the process of personally visiting and confirming a facility management document storage or a site by a person, and the process of confirming the drawings or history information related to the facility is complicated.

If the period of warranty for the facility is expired when the history information is confirmed and a contract should be made with a new facility management company, the process of confirming and providing the data requested by the company in relation to the maintenance work from the facility management document storage, the management information system and the site is continuously repeated.

At this point, the facility information or history information is generally managed as a Word document or an Excel file. The drawings are managed as PDF files or partially non-electronized blue print drawings, and some pieces of information on the history of the work and maintenance are separately managed in the management information system (MIS).

In this circumstance, if a defect occurs in a facility, it takes a long time for the facility manager to search for the history information, documents, information on the management company, location of the site, MIS history information and the like connected around the facility, and it is also the same for the facility management company. This is one of the main factors which lowers efficiency of a work in managing the facility.

If the processes of confirming and collecting the scattered data can be integrated around a facility object unlike the conventional processes described above, efficiency of a work for requesting, searching, confirming and integrating the facility management data can be improved. If a facility is defined as a BIM entity considering convenience of confirming, searching and managing the data and related information is searched for in connection with the BIM entity, the problems described above can be improved.

Accordingly, if the facility management system using perspective definition metadata as shown in FIG. 2 is completed, a central server at the center manages a facility management database, and thus diversely scattered data can be integrated and centrally processed in response to a request of other constitutional components.

According to a preferred embodiment of the present invention, an effect of improving at least six processes of the conventional FM work scenario (5. The facility manager confirms a location, a structure and history of the work/maintenance. 8. A worker confirms the site of the facility. 9. The worker requests data related to the field work. 10. The facility manager provides data related to the field work. 18. The worker submits the results and products before and after the maintenance work. 20. The facility manager updates history of drawings and documents.) can be accomplished.

In FIG. 2, the facility management system using perspective definition metadata according to a preferred embodiment of the present invention may be configured to include a central server 100, a user terminal 200, a facility management company server 300 and a management information system 400, and the central server 100 includes a facility management database 110.

The central server 100 receives a request for maintenance from the user terminal 200, confirms a site having a defect, confirms work/maintenance history from the facility management database 110, confirms a location, a structure and history of the work/maintenance from the facility management database 110, makes a work plan, transmits a request for a quotation of the work of a company to the facility management company server 300, receives a request for data related to the field work from the facility management company server 300, transmits the data related to the field work to the facility management company server 300, receives the quotation of the work of the company from the facility management company server 300, reviews the quotation of the company, requests the management information system 400 to approve progress of the work, receives approval of progressing the work from the management information system 400, transmits a contract with the company and a request for the work to the facility management company server 300, receives results and products before and after the maintenance work from the facility management company server 300, transmits a request for on-site confirmation on the result of the maintenance work to the user terminal 200, updates history of drawings and documents in the facility management database 110, receives a request for payment of work expenses from the facility management company server 300, requests the management information system 400 to approve the work expenses, receives approval of the work expenses and information on registration of history from the management information system 400, receives the result of the maintenance work from the user terminal 200, and transmits information on the payment of the work expenses to facility management company server 300.

In addition, the user terminal 200 transmits a request for maintenance to the central server 100, receives a request for on-site confirmation on the result of the maintenance work from the central server 100, and transmits the result of the maintenance work to the central server 100.

In addition, the facility management company server 300 receives a request for a quotation of the work of the company from the central server 100, transmits a request for data related to the field work to the central server 100, receives the data related to the field work from the central server 100, transmits a quotation of the work of the company to the central server 100, receives a contract with the company and a request for the work from the central server 100, transmits results and products before and after the maintenance work to the central server 100, transmits a request for payment of work expenses to the central server 100, and receives information on the payment of the work expenses from the central server 100.

Then, the management information system 400 receives a request for approving progress of the work from the central server 100, transmits approval of progressing the work to the central server 100, receives a request for approving work expenses from the central server 100, and transmits approval of the work expenses and information on registration of history to the central server 100.

Additionally, an operator or a worker of the facility management company server 300 confirms offline a site where a defect is occurred, actually performs a maintenance work, and confirms offline results before and after the maintenance work.

Meanwhile, the central server 100 includes a collection means, a classification means and an expression means in order to use a metadata structure based on perspectives of information in a preferred embodiment of the present invention.

The collection means collects heterogeneous data related to an FM work, and the collection target heterogeneous data may be collected from a separate system in the form of an XML file, and the collected heterogeneous data can be stored in the facility management database 110.

The classification means classifies the heterogeneous data collected by the collection means according to a classification target criterion, and the classified heterogeneous data may also be stored in the facility management database 110, and the classification target criterion may include a user's perspective, a manager's perspective and a worker's perspective.

For example, when a facility manager logs in the central server 100, the manager may desire to confirm the state of the facility, or an operator operating the facility management company server 300 or a worker who actually carries out a maintenance work may desire to confirm information on the building structure or information on the maintenance history. Therefore, data required for each perspective should be collected in advance, and information classified according to the perspectives should be shown by the user, by the manager and by the worker.

In a preferred embodiment of the present invention, the user's perspective information among the information classified by the classification means may be information on a corresponding manager, information on the facility number, information on the area of the facility or the like, and the manager's perspective information may be information on the number of stories of the facility, information on the classification of the facility, information on the name of the facility, information on the date of facility, information on the area of the facility, information on the boundary of the facility, information on the size of the facility, information on the height of the facility or the like, and the worker's perspective information may be information on the current state of maintenance, information on the ratio of maintenance, information on the date of maintenance or the like.

Particularly, when the classification means classifies the heterogeneous data, the classification target data are expressed in a hierarchy of properties of data, such as a category, a name, a value, a type or the like, and extracted properties of the data are formalized as a category, a property name, a property value, a property type and the like using metadata and scripts. That is, they are expressed and processed as Property={Category, Name, Value, Type}.

The expression means expresses the classified heterogeneous data in an optimum style according to an entity which accesses the central server 100, such as a user, a manager or a worker, and they are displayed on the screen of the user terminal 200, a separate manager terminal or a separate worker terminal in the form of an XML file.

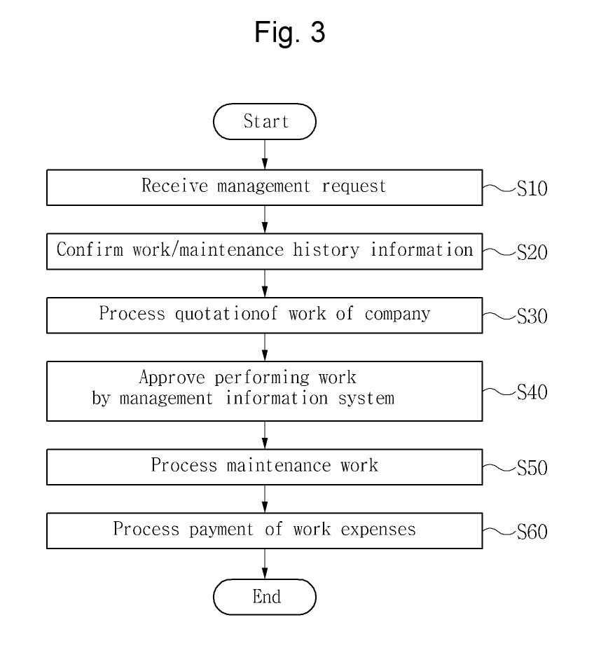

Hereinafter, a facility management method using perspective definition metadata according to a preferred embodiment of the present invention will be described in detail with reference to FIG. 3.

FIG. 3 is an entire flowchart illustrating a facility management method using perspective definition metadata according to a preferred embodiment of the present invention.

First, as shown in FIG. 3, the central server 100 receives a request for maintenance from the user terminal 200 and confirms information on a site having a defect (S10).

Next, the central server 100 confirms work/maintenance history information from the facility management database 110 and confirms information on the location, structure and history of the work/maintenance from the facility management database 110 (S20).

Next, the central server 100 creates work plan information, transmits a request for a quotation of the work of the company to the facility management company server 300, receives a request for data related to the field work from the facility management company server 300, transmits the data related to the field work to the facility management company server 300, and receives the quotation of the work of the company from the facility management company server 300 (S30).

Next, the central server 100 reviews the quotation of the company, requests the management information system 400 to approve progress of the work, and receives approval of progressing the work from the management information system 400 (S40).

Next, the central server 100 transmits a contract with the company and a request for the work to the facility management company server 300, receives results and products before and after the maintenance work from the facility management company server 300, transmits a request for on-site confirmation on the result of the maintenance work to the user terminal 200, and updates history of drawings and documents in the facility management database 110 (S50).

Finally, the central server 100 receives a request for payment of work expenses from the facility management company server 300, requests the management information system 400 to approve the work expenses, receives approval of the work expenses and information on registration of history from the management information system 400, receives a result of the maintenance work from the user terminal 200, and transmits information on the payment of the work expenses to facility management company server 300 (S60).

According to the present invention, there is an effect of providing a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

As disclosed herein, in an embodiment, a method of varying or expanding a facility management system is provided. The method includes collecting data related to facility management from a plurality of data sources, and receiving a request for maintenance from a user terminal, by a central server. As previously disclosed, the data may include information entered by a user of the user terminal, information entered by a manager, and information entered by a worker.

The request for maintenance includes only that information needed from a perspective of a user of the user terminal. Thus, the user of the user terminal may be selective in choosing which information is needed from for the request for maintenance, e.g., the information is based on the perspective of the user of the user terminal.

The information selected by the user corresponds to data previously collected from the plurality of data sources. For example, as previously described, the data previously collected may include information on the facility number, the area of the facility, the number of stories of the facility, the classification of the facility, the name of the facility, the date of facility, the area of the facility, the boundary of the facility, the size of the facility, the height of the facility, the current state of maintenance, the ratio of maintenance, the date of maintenance, or a combination thereof. Thus, the information corresponding to data previously collected may include the facility number, the area of the facility, the number of stories of the facility, the classification of the facility, the name of the facility, the date of facility, the area of the facility, the boundary of the facility, the size of the facility, the height of the facility, the current state of maintenance, the ratio of maintenance, the date of maintenance, or a combination thereof.

The method further includes transmitting a request for a quotation to a facility management company server based on the information, by the central server, and after transmitting the request, adding additional data related to facility management or changing at least a portion of the data related to facility management.

In an embodiment, after transmitting the request, additional data related to facility management not previously collected, for example, information on the facility number, the area of the facility, the number of stories of the facility, the classification of the facility, the name of the facility, the date of facility, the area of the facility, the boundary of the facility, the size of the facility, the height of the facility, the current state of maintenance, the ratio of maintenance, the date of maintenance, or a combination thereof, may be added to the facility management system. Thus, the facility management system may be expanded.

In an embodiment, after transmitting the request, at least a portion of the data related to facility management may be changed. For example, previously collected data on the facility number, the area of the facility, the number of stories of the facility, the classification of the facility, the name of the facility, the date of facility, the area of the facility, the boundary of the facility, the size of the facility, the height of the facility, the current state of maintenance, the ratio of maintenance, the date of maintenance, or a combination thereof, may be changed. Thus, the facility management system may be varied.

With regard to collection of data related to facility management, one or more input interfaces may allow for input of data with other devices that may be connected to the central server. For example, an input interface may provide a connection to one or more external devices such as a keyboard, computer mouse, touch screen, virtual keyboard, touch pad, pointing device, or other human interface devices. External devices may also include portable computer-readable storage media such as, for example, thumb drives, portable optical or magnetic disks, and memory cards. The input interface may also connect to a display.

The display may provide a mechanism to display data to a user and may be, for example, a computer monitor. The display may also be an incorporated display and may function as a touch screen, such as a built-in display of a tablet computer.

The input interfaces may be the same or may differ for the collection of data related to facility management from the plurality of data sources, the addition of additional data related to facility management, or the changing at least a portion of the data related to facility management.

Receiving the request for maintenance from the user terminal and/or transmitting the request for the quotation may include use of a transmission device that receives one or more communication signals from a communication network or other communications device that include data and generates guided waves to convey the data via a transmission medium to the transmission device. The transmission device receives the guided waves and converts them to communication signals that include the data for transmission to a communications network or other communications device.

The communication network or networks may include a wireless communication network such as a cellular voice and data network, a wireless local area network, a satellite communications network, a personal area network or other wireless network. The communication network or networks may include a wired communication network such as a telephone network, an Ethernet network, a local area network, a wide area network such as the Internet, a broadband access network, a cable network, a fiber optic network, other wired network, or a combination thereof. The communication devices may include a network edge device, bridge device or home gateway, a set-top box, broadband modem, telephone adapter, access point, base station, other fixed communication device, or a combination thereof, a mobile communication device such as an automotive gateway, laptop computer, tablet, smartphone, cellular telephone, other communication device, or a combination thereof.

Receiving the request for maintenance from the user terminal and/or transmitting the request for the quotation may include use of a communications interface that may comprise a wireless interface for interfacing to the central server utilizing any of various wireless signaling protocols (e.g., LTE, WiFi, WiMAX, etc.). The communications interface may also comprise a wired interface such as a fiber optic line, coaxial cable, twisted pair, other suitable wired mediums for transmitting signals to the central server, or a combination thereof.

The method may further include displaying the information needed from the perspective of the user in a style desired by the user. As previously described, the display may be, for example, a computer monitor. The display can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invent ion. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of varying or expanding a facility management system, the method comprising:
collecting data related to facility management from a plurality of data sources;
receiving a request for maintenance from a user terminal, by a central server, wherein the request for maintenance includes only that information needed from a perspective of a user of the user terminal, the information corresponding to data previously collected from the plurality of data sources;
transmitting a request for a quotation to a facility management company server based on the information, by the central server; and
after transmitting the request, adding additional data related to facility management or changing at least a portion of the data related to facility management.

2. The method of claim 1, wherein the method comprises adding additional data related to facility management.

3. The method of claim 1, wherein the method comprises changing at least a portion of the data related to facility management.

4. The method of claim 1, wherein the data includes:
information entered by the user;
information entered by a manager; and
information entered by a worker.

5. The method of claim 1, further comprising displaying the information needed from the perspective of the user in a style desired by the user.
